(19) United States
(12) Patent Application Publication
(10) Pub. No.: US 2026/0008039 A1
(43) Pub. Date: Jan. 8, 2026

(54) REFORMING CATALYST

(71) Applicant: Murata Manufacturing Co., Ltd., Nagaokakyo-shi (JP)

(72) Inventor: Naoya MORI, Nagaokakyo-shi (JP)

(21) Appl. No.: 19/325,592

(22) Filed: Sep. 11, 2025

Related U.S. Application Data
(63) Continuation of application No. PCT/JP2024/009087, filed on Mar. 8, 2024.

(30) Foreign Application Priority Data
Mar. 23, 2023 (JP) 2023-047176

(51) Int. Cl. B01J 35/33; B01J 23/10; B01J 23/63; B01J 33/00; B01J 35/57

(52) U.S. Cl. CPC B01J 35/33; B01J 23/10; B01J 23/63; B01J 33/00; B01J 35/57

(57) ABSTRACT

An electric field catalyst that includes: a porous honeycomb substrate; a catalyst layer covering a surface of the porous honeycomb substrate; and a high-resistance layer that is higher in electrical resistivity than the catalyst layer between the honeycomb substrate and the catalyst layer.

### CROSS REFERENCE TO RELATED APPLICATIONS

The present application is a continuation of International application No. PCT/JP2024/009087, filed Mar. 8, 2024, which claims priority to Japanese Patent Application No. 2023-047176, filed Mar. 23, 2023, the entire contents of each of which are incorporated herein by reference.

### TECHNICAL FIELD

The present disclosure relates to a reforming catalyst, particularly an electric-field catalyst for reforming.

### BACKGROUND ART

In recent years, electric-field catalysts which are used under application of an electric field have become popular (for example, Patent Document 1). The electric-field catalyst is attracting attention as a new catalyst, because it can induce a catalytic reaction even at a relatively low temperature as compared to general catalysts when used while electric energy is imparted thereto.

An electric-field catalyst disclosed in Patent Document 1 is a catalyst including a honeycomb-structured support composed of an insulating material and a catalyst layer formed on the support so that the catalyst facilitates a reaction under application of an electric field through electrodes brought into contact with the support and/or the catalyst layer. The catalyst layer is formed by sintering catalytic particles, which are composed of carrier particles of mixed ionic-electronic conductive ceramic having a catalytic metal carried thereon, and the resistivity across the catalyst between the electrodes measured at 450° C. is 50 Ω·m to 270 Ω·m.
Patent Document 1: Japanese Unexamined Patent Application Publication No. 2017-87088

### SUMMARY OF THE DISCLOSURE

In reformation of steam through a catalyst, it is advantageous that the catalytic reaction be induced at a temperature lower than the above, since a heat-resistant temperature required for a reaction apparatus can be set to be low.

In Patent Document 1, the lower limit of the reaction temperature for reformation of steam through the electric-field catalyst is set to 450° C., and there is a desire for an electric-field catalyst capable of inducing a catalytic reaction at a lower temperature (e.g., 300° C.).

One object of an embodiment of the present disclosure is to provide a catalyst to be used under application of an electric field which can induce a catalytic reaction at a relatively low reaction temperature as compared to conventional catalysts.

A first aspect of the present disclosure provides an electric field catalyst that includes: a porous honeycomb substrate; a catalyst layer covering a surface of the porous honeycomb substrate; and a high-resistance layer that is higher in electrical resistivity than the catalyst layer between the porous honeycomb substrate and the catalyst layer.

A second aspect of the present disclosure provides the electric field catalyst according to the first aspect, in which an electrical resistivity of the high-resistance layer is higher than or equal to twice an electrical resistivity of the catalyst layer.

A third aspect of the present disclosure provides the electric field catalyst according to the first or second aspect, in which holes of the porous honeycomb substrate are open on the surface of the honeycomb substrate, and at least part of the holes are filled with the high-resistance layer.

A fourth aspect of the present disclosure provides the electric field catalyst according to any one of the first to third aspects, in which the catalyst layer comprises an electric-field catalyst material containing Ru, Ba, Zr, Y, and O, and the high-resistance layer comprises an insulating material containing Ba, Zr, Y, and O.

The electric field catalyst according to an embodiment of the present disclosure can induce a catalytic reaction at a low reaction temperature as compared to conventional catalysts when used under application of an electric field.

### BRIEF DESCRIPTION OF THE DRAWINGS

FIG. 1 is a schematic sectional view for description of a catalyst according to an embodiment of the present disclosure.

FIG. 2 is a partially enlarged sectional view illustrating region A in FIG. 1.

FIG. 3 is a partially enlarged sectional view illustrating region B in FIG. 2.

FIG. 4 is a partially enlarged schematic sectional view for description of a catalyst according to a first modification.

FIG. 5 is a partially enlarged schematic sectional view for description of a catalyst according to a second modification.

FIG. 6 is a schematic view illustrating one example of a reaction apparatus to be used in a gas-reforming method in which the catalyst is used.

### DESCRIPTION OF THE PREFERRED EMBODIMENTS

An issue specific to electric-field catalysts is that how the electric energy applied thereto can be utilized for activating the catalytic reaction. To solve such an issue, Patent Document 1 proposes that the resistivity across the catalyst at 450° C. be controlled within a range of 50 Ω·m to 270 Ω·m.

It is considered that “450° C.” is a lower temperature limit of the steam reforming reaction, and Patent Document 1 is based on the assumption that the catalytic reaction be performed at 450° C. or more. A reaction temperature of 450° C. is such a temperature that allows the catalytic reaction to proceed to some extent even when the electric power applied to the electric-field catalyst is 0 W (that is, in the state where no electric field is applied).

The present inventor has made intensive studies to obtain an electric-field catalyst that can achieve the steam reforming reaction or the like even at a further reduced temperature, specifically, at such a reaction temperature that does not allow the catalytic reaction to proceed when the electric power applied is 0 W (for example, 300° C.). As a result, the present inventor has found that the catalytic reaction can be induced even at a low reaction temperature in the case where a high-resistance layer is provided between a substrate and a catalyst layer, the high-resistance layer being higher in electrical resistance than the catalyst layer, and has completed the present disclosure.

A catalyst according to an embodiment will be described in detail below.

### (Catalyst 100)

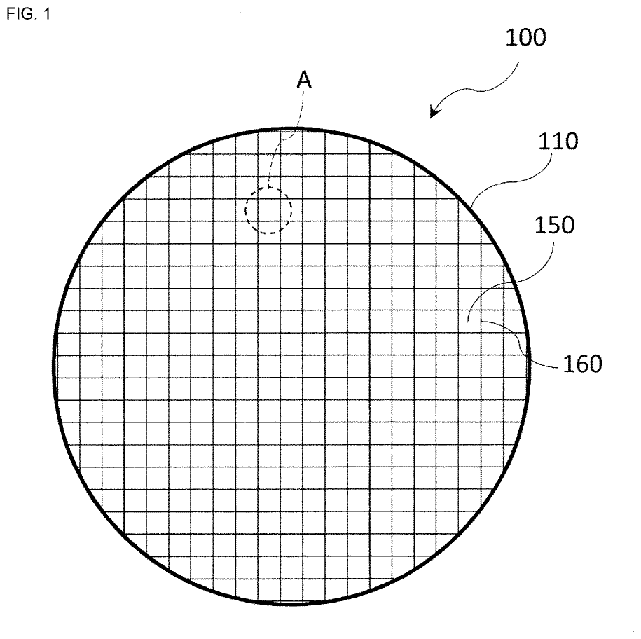

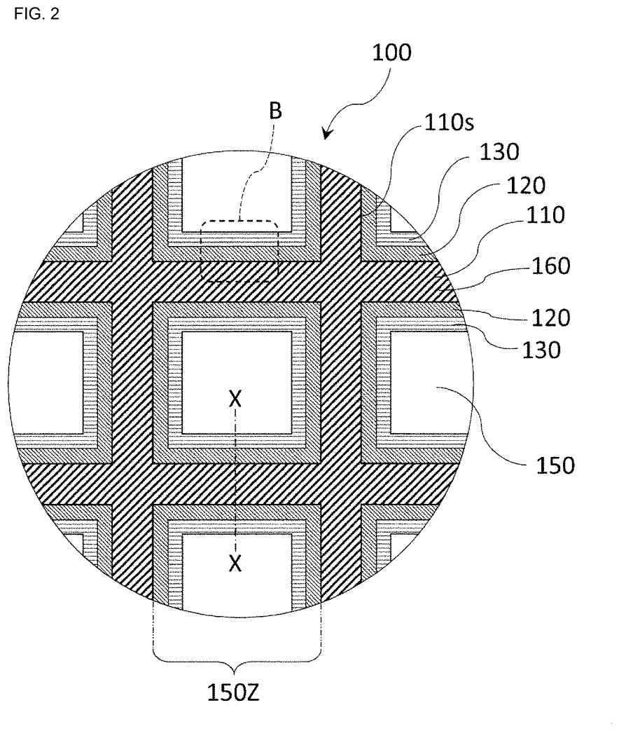

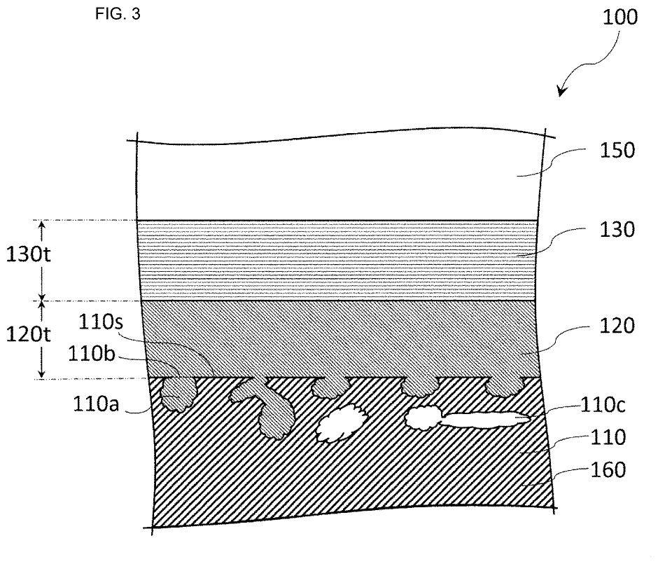

FIG. 1 is a schematic sectional view of a catalyst 100 according to an embodiment of the present disclosure, FIG. 2 is a partially enlarged sectional view illustrating region A of FIG. 1, and FIG. 3 is a partially enlarged sectional view of region B of FIG. 2.

The catalyst 100 is a so-called electric-field catalyst, which is used under application of an electric field. The catalyst 100 includes a honeycomb substrate 110 having porousness, and a catalyst layer 130 with which a surface 110s of the honeycomb substrate 110 are coated.

The honeycomb substrate 110 illustrated in FIG. 1 has a cylindrical outer shape, and a plurality of cells 150 (gas passages, through which gas being treated passes) inside the honeycomb substrate 110. The cells 150 extend in the axial direction of the cylindrical shape (in the direction perpendicular to the drawing plane of FIG. 1). The honeycomb substrate 110 exemplified in FIG. 1 is of a type having the cells 150 which are rectangular in cross section, and other known examples include honeycomb substrates having cells which are hexagonal or circular in cross section.

The neighboring cells 150 are isolated from each other by a partition wall 160.

The phrase “the surface 110s of the honeycomb substrate 110” herein refers to the inner surfaces of the cells 150 of the honeycomb substrate 110, namely, the surfaces of the partition walls 160.

The gas being treated which passes through the cells 150 comes into contact with the surface 110s of the honeycomb substrate 110. Therefore, due to the catalyst layer 130 formed to coat the surface 110s, the gas being treated is brought into contact with the catalyst layer 130 and thus the gas treatment is facilitated.

The catalyst 100 according to the embodiment has a high-resistance layer 120 between the honeycomb substrate 110 and the catalyst layer 130. The high-resistance layer 120 is higher in electrical resistivity than the catalyst layer 130.

Due to the high-resistance layer 120 provided between the honeycomb substrate 110 and the catalyst layer 130, electric current can be focused on the catalyst layer 130 when an electric field is applied to the catalyst 100. This means that, since the electric energy is focused on the catalyst layer 130, the electric energy is efficiently utilized for the catalytic reaction which takes place in the catalyst layer 130. Consequently, the catalytic reaction can be induced even at such a low temperature that conventionally does not induce the catalytic reaction.

It may be difficult to directly measure the electrical resistivities of the catalyst layer 130 and the high-resistance layer 120, since they are formed thinly on the surface 110s of the honeycomb substrate 110. In such a case, an actual product of the catalyst 100 is analyzed to determine the chemical composition and the texture (in particular, porosity) of each of the catalyst layer 130 and the high-resistance layer 120, and a sample having the same chemical composition and texture is produced. By measuring the electrical resistivity of the sample, the electrical resistivity of each of the catalyst layer 130 and the high-resistance layer 120 can be estimated.

The electrical resistivity of the high-resistance layer 120 is preferably higher than or equal to twice the electrical resistivity of the catalyst layer 130. That is, (the electrical resistivity of the high-resistance layer 120)/(the electrical resistivity of the catalyst layer 130) is preferably 2.0 or more. This is expected to make the effect of focusing the electric current on the catalyst layer 130 more remarkable.

(The electrical resistivity of the high-resistance layer 120)/(the electrical resistivity of the catalyst layer 130) is more preferably 3.0 or more, further preferably 10.0 or more, particularly preferably 50.0 or more.

As shown in FIG. 3, holes 110a (open pores) due to porousness may be open on the surface 110s of the honeycomb substrate 110. At least part of the holes 110a are preferably filled with the high-resistance layer 120.

The phrase “at least part of the holes 110a” as used herein may include two meanings.

The first meaning is that, among the plurality of holes 110a, some of the holes 110a are filled with the high-resistance layer 120 whereas the other holes 110a are not.

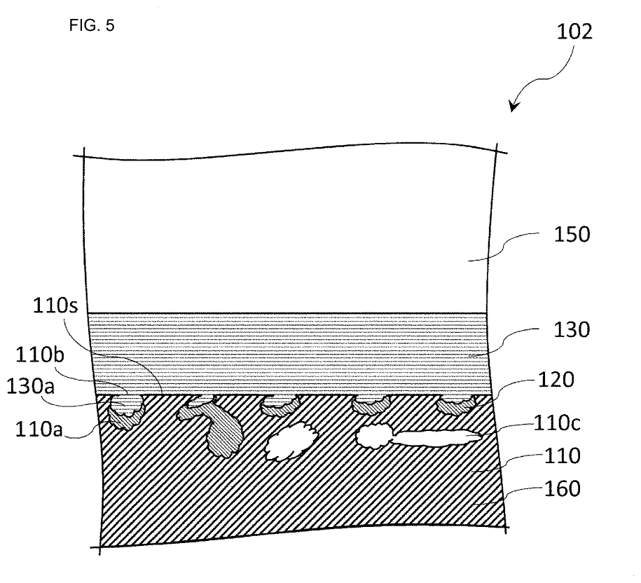

The second meaning is that, in each of the plurality of holes, part of the pore volume of the hole is filled with the high-resistance layer 120 (for example, see FIG. 5). The second meaning will be described in detail below with reference to FIGS. 3 to 5.

In an example of the catalyst 100 illustrated in FIG. 3, the high-resistance layer 120 fills all of the holes 110a, and furthermore, entirely coats the surface 110s of the honeycomb substrate 110.

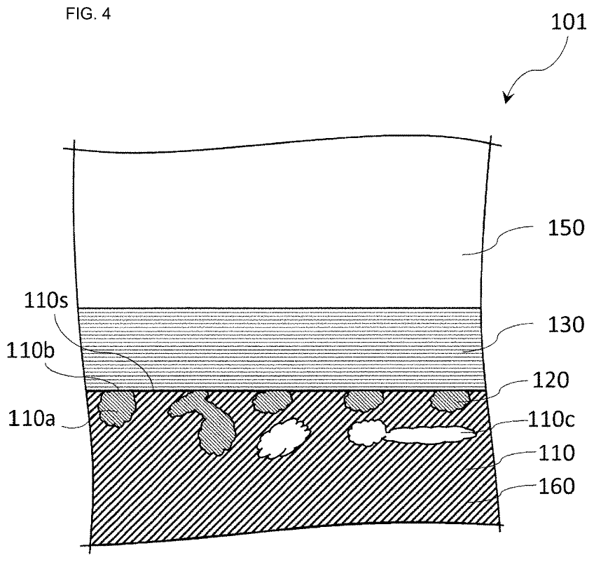

FIG. 4 illustrates a catalyst 101 according to a first modification, in which the high-resistance layer 120 fills all of the holes 110a, and the surface of the high-resistance layer 120 and the surface 110s of the honeycomb substrate 110 are almost on the same plane. In the first modification, the surface 110s of the honeycomb substrate 110 is not coated with the high-resistance layer 120.

FIG. 5 illustrates a catalyst 102 according to a second modification, in which the high-resistance layer 120 fills part of an inner cavity of each of the holes 110a. Therefore, the surface of the high-resistance layer 120 does not reach the surface 110s of the honeycomb substrate 110, and even after the high-resistance layer 120 is formed, the surface 110s of the honeycomb substrate 110 has recessed portions resulting from the holes 110a which are not completely filled (though shallower than those before the high-resistance layer 120 is formed). The recessed portions are filled with part 130a of the catalyst layer 130, which is subsequently formed.

Since the high-resistance layer 120 at least partially fills the holes 110a being open on the surface 110s of the honeycomb substrate 110, the volume of “the part 130a of the catalyst layer 130” which enters the holes 110a can be reduced, as compared to the case where the high-resistance layer 120 is not provided. As a result, the following effects are expected.

Since the gas being treated which passes through the cells 150 does not tend to reach the part 130a of the catalyst layer 130 inside the holes 110a, the part 130a of the catalyst layer 130 scarcely contributes to the catalytic reaction. However, when an electric field is applied to the catalyst, electric current flows also in the part 130a of the catalyst layer 130 inside the holes 110a. That is, since the electric current flows in a region of the catalyst layer 130 which does not contribute to the catalytic reaction, the amount of electric current which contributes to the catalytic reaction decreases.

Filling at least part of the holes 110a with the high-resistance layer 120 reduces the amount of the catalyst layer 130 which enters the holes 110a, thereby reducing the amount of electric current which does not contribute to the catalytic reaction (that is, increasing the amount of electric current which contributes to the catalytic reaction) and thus facilitating the catalytic reaction.

In addition, since the catalyst layer 130 which enters the holes 110a can be reduced, an effect of reducing the amount of catalyst material used at the time of forming the catalyst layer 130 can be expected.

The above effects are enhanced as the proportion of the volume filled with the high-resistance layer 120 of the pore volume of the hole 110a increases. Therefore, it is particularly preferable that all of the holes 110a be filled with the high-resistance layer 120 (FIGS. 3 and 4). This configuration allows a thickness 130t of the catalyst layer 130 (see FIG. 3) to be uniform throughout the whole catalyst layer 130, and therefore, not only the above effects but also an effect of further reducing an imbalance in electric current and thus more efficiently facilitating the catalytic reaction can be expected.

Note that, even when part of the hole 110a is not filled with the high-resistance layer 120, the same effect as that achieved in the case where the hole 110a is completely filled with the high-resistance layer 120 can be achieved, as long as the catalyst layer 130 cannot penetrate inside the surface 110s of the honeycomb substrate 110. For example, even when a cavity not filled with the high-resistance layer 120 is left inside the hole 110a, the catalyst layer 130 cannot penetrate into the cavity as long as an opening 110b of the hole 110a is completely covered with the high-resistance layer 120. Therefore, the same effect as that achieved in the case where it is completely filled can be expected.

In the catalysts 101 and 102 illustrated in FIGS. 4 and 5, the surface 110s of the honeycomb substrate 110 is not coated with the high-resistance layer 120. In this case, the surface 110s of the honeycomb substrate 110 is in contact with the catalyst layer 130. Depending on the combination of a material constituting the honeycomb substrate 110 and a catalyst material constituting the catalyst layer 130, a chemical reaction between the honeycomb substrate 110 and the catalyst layer 130 can occur, possibly causing an adverse effect on the catalytic reaction.

Therefore, it is particularly preferable that the surface 110s of the honeycomb substrate 110 be completely coated with the high-resistance layer 120 so that the surface 110s of the honeycomb substrate 110 is prevented from coming into contact with the catalyst layer 130, as in the catalyst 100 illustrated in FIG. 3.

Although the holes 110a (open pores) being open on the surface 110s of the honeycomb substrate 110 have been described above, the honeycomb substrate 110 having porousness also has pores 110c (closed pores) inside the partition wall 160, being not open on the surface 110s. The pores 110c may be filled or unfilled with the high-resistance layer 120.

A thickness 120t of the high-resistance layer 120 is not limited, and the thickness 120t is, for example, 0 μm to 70 μm, preferably 5 μm to 70 μm, more preferably 10 μm to 40 μm.

Note that, in the case where the high-resistance layer 120 fills only part of the holes 110a as in the case illustrated in FIG. 5, the thickness of the high-resistance layer 120 may be determined to be 0 μm despite the high-resistance layer 120 being present between the honeycomb substrate 110 (more specifically, the inner surfaces of the holes 110a of the honeycomb substrate 110) and the catalyst layer 130, because the thickness 120t of the high-resistance layer 120 is measured from the surface 110s of the honeycomb substrate 110.

The thickness 130t of the catalyst layer 130 is preferably 5 μm to 80 μm, more preferably 10 μm to 50 μm, particularly preferably 20 μm to 40 μm.

A large thickness of the high-resistance layer 120 and the catalyst layer 130 necessitates a large amount of material, and increases the risk of clogging of the cells 150 of the honeycomb substrate 110 at the time of coating. In the case of, for example, the honeycomb substrate 110 of 3 mil/750 cpsi, the total thickness of the high-resistance layer 120 and the catalyst layer 130 is preferably 80 μm or less.

The thickness 120t of the high-resistance layer 120 and the thickness 130t of the catalyst layer 130 are measured by observing cross-sectional surfaces of a sample by SEM (at a magnification of 1000 or 2000).

The honeycomb substrate 110 is cut to obtain a cross section (the cross section illustrated in FIGS. 1 and 2) orthogonal to the direction in which the cells 150 extend (the direction of the flow passage for the gas being treated). On the cross section, the thickness 130t of the catalyst layer 130 and the thickness 120t of the high-resistance layer 120 in the direction orthogonal to one side 150L of the cell 150 (the direction along line X-X in FIG. 2) are measured almost at the center position of the one side of the cell 150.

Three cross sections are prepared, and in each of the sections, the thicknesses are measured in randomly extracted three sides.

Note that the cross sections are prepared in other than the 1/10 regions from both ends of the honeycomb substrate 110 with respect to its overall length (the dimension of the honeycomb substrate 110 in the direction in which the cells 150 extend). In addition, the three sides are randomly extracted from other than the 1/10 region from the outer periphery.

The catalyst layer 130 can be formed from an electric-field catalyst material containing Ru, Ba, Zr, Y, and O, whereas the high-resistance layer 120 can be formed from an insulating material containing Ba, Zr, Y, and O.

Specifically, a suitable electric-field catalyst material constituting the catalyst layer 130 contains an oxide of Ba, Zr, and Y (chemical formula: Ba(Zr,Y)O₃) as a principal component, and Ru added thereto as an active metal. The electrical conductivity (electrical resistivity) of the catalyst layer 130 can be controlled by controlling the amount of Ru added.

When the content of Ba is taken as 1.0 mol, the content of each of the elements (Y and Ru) is preferably as follows.
Y: 0 to 0.03 mol
Ru: 0.04 to 0.20 mol

When the content of Y falls within the above range, a catalyst material which exhibits a high electric-field activity can be obtained.

When the content of Ru falls within the above range, the catalyst layer 130 can have a sufficiently low electrical resistivity, and at the same time, a catalyst material which exhibits a high electric-field activity can be obtained. Although adding Ru in an amount exceeding 0.20 mol, which is the upper limit of Ru, does not cause an adverse effect on the catalytic action, it merely causes an increase in cost while the electric-field catalyst activity reaches a point of saturation; accordingly, the preferable upper limit is set to 0.20 mol.

When the content of Ba is taken as 1.0 mol, the content of each of Y and Ru is more preferably as follows.
Y: 0 to 0.02 mol
Ru: 0.04 to 0.12 mol

The insulating material constituting the high-resistance layer 120 contains an oxide of Ba, Zr, and Y (chemical formula: Ba(Zr,Y)O₃) as a principal component. The high-resistance layer 120 has an insulating property, since it does not contain Ru, which imparts the electrical conductivity.

Since the principal component of the catalyst layer 130 and the principal component of the high-resistance layer 120 are the same, a chemical reaction is not likely to occur between the catalyst layer 130 and the high-resistance layer 120, and accordingly, deterioration of the catalyst layer 130 in terms of catalytic reactivity due to the chemical reaction can be reduced.

Examples of the catalyst material constituting the catalyst layer 130 further include materials which can induce the reforming reaction in an electric field, such as YSZ containing Ni, BaZrO₃-based materials containing Ni, and CeO₂-based materials carrying at least one of Pd, Pt, Rh, and Ru.

The insulating material constituting the high-resistance layer 120 is not limited as long as it has a higher electrical resistivity than that of the catalyst layer 130, and examples thereof include general ceramics such as Al₂O₃. In addition, it is desirable to select a material that has a low reactivity with, and is similar in thermal expansion coefficient to, any of the materials constituting the honeycomb substrate 110 to be employed (normally, an insulating material) and the catalyst material constituting the catalyst layer 130.

The honeycomb substrate 110 having porousness is normally made of an insulating material. This reduces electric current flowing through the honeycomb substrate 110 during application of an electric field to the electric-field catalyst, thereby focusing the electric current on the catalyst layer 130.

Examples of a material suitable for the honeycomb substrate 110 include cordierite.

### (Method of Manufacturing the Catalyst 100)

The method of manufacturing the catalyst 100 includes, in the below order:
1) a step of preparing the honeycomb substrate 110,
2) a step of forming the high-resistance layer 120, and
3) a step of forming the catalyst layer 130.

A generally known method may be employed as the method of manufacturing the catalyst 100. A typical method of manufacturing the catalyst 100 will be described below.

### Step 1) the Step of Preparing the Honeycomb Substrate 110

The honeycomb substrate 110 is obtained by extrusion-molding a ceramic having an appropriate resistivity (e.g., cordierite, alumina, or stabilized zirconia), followed by drying and firing. In the case of cordierite, a commercially available honeycomb substrate may be used.

### Step 2) the Step of Forming the High-Resistance Layer

The high-resistance layer 120 is formed from, for example, an insulating material.

A method of synthesizing the insulating material is not limited, and synthesis methods such as a solid-phase method and a coprecipitation method which are employed in synthesizing ceramic materials may be employed. The description herein is for the case of the solid-phase method.

Raw materials (for example, BaCO₃ and ZrO₂ in the case where the materials are for use in hydrocarbon reformation) are prepared and weighed so as to have predetermined mole ratios, and subjected to wet blending together with round pebbles and water added thereto, thereby obtaining a mixture.

The resulting mixture is dried in an oven at a temperature of 100° C. to 150° C., and then fired under conditions of 900° C. to 1300° C. in an air atmosphere for 1 to 6 hours, thereby obtaining an insulating material.

The resulting insulating material, water as a solvent, and an optional pore-forming agent (carbon, a resin, or the like) are mixed and blended in a ball mill for 2 hours, thereby preparing slurry for coating. The pore-forming agent serves to control the porosity of the high-resistance layer 120 and the size of the pores, thereby reducing a stress generated due to a difference in thermal expansion coefficient from the honeycomb substrate 110.

All the surfaces of the honeycomb substrate 110 are coated (wash-coated) with a predetermined amount of the slurry for the high-resistance layer 120, followed by drying, thereby forming the high-resistance layer 120 (containing the pore-forming agent).

### Step 3) the Step of Forming the Catalyst Layer 130

Raw materials (for example, BaCO₃, ZrO₂, and RuO₂ in the case where the materials are for use in hydrocarbon reformation) are prepared and weighed so as to have predetermined mole ratios, and subjected to wet blending together with round pebbles and water added thereto, thereby obtaining a mixture.

The resulting mixture is dried in an oven at a temperature of 100° C. to 150° C., and then fired under conditions of 900° C. to 1200° C. in an air atmosphere for 1 to 6 hours, thereby obtaining a catalyst material.

The resulting catalyst material, water as a solvent, and an optional pore-forming agent (carbon, a resin, or the like) are mixed and blended in a ball mill for 2 hours, thereby preparing slurry for coating. The pore-forming agent serves to control the porosity of the catalyst layer 130 and the size of the pores, thereby reducing a stress generated due to a difference in thermal expansion coefficient from the honeycomb substrate 110. In addition, a path for supplying the gas being treated into the inside of the catalyst layer 130 can be formed.

All the surfaces of the honeycomb substrate 110 having the high-resistance layer 120 formed thereon are coated (wash-coated) with a predetermined amount of the slurry for the catalyst layer 130, followed by drying, thereby forming the catalyst layer 130 (containing the pore-forming agent). The resulting object is subsequently fired at 500° C. to 900° C. for 1 to 6 hours. The pore-forming agent optionally added is eliminated during the firing due to combustion, thermal decomposition, or the like.

In this manner, the catalyst 100 according to the embodiment can be formed.

The manufacturing method described herein is merely an example, and it goes without saying that those skilled in the art can manufacture the catalyst 100 according to the embodiment by another method in consideration of publicly known techniques.

### (Gas-Reforming Apparatus Including the Catalyst 100)

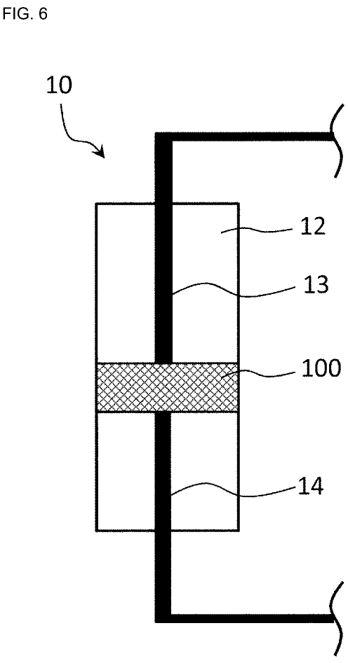

FIG. 6 is a schematic view illustrating one example of a reaction apparatus 10, which is used in the gas-reforming method in which the catalyst 100 according to the embodiment is used.

For example, an atmospheric fixed-bed flow reactor having a pair of electrodes 13 and 14 can be used as the reaction apparatus 10. The catalyst 100 is placed inside a reaction vessel 12 of the atmospheric fixed-bed flow reactor (reaction apparatus 10), and the pair of electrodes 13 and 14 are respectively brought into direct contact with both ends of the catalyst 100. In the case of reforming a gas, voltage is applied between the pair of electrodes 13 and 14 so that an electric field is applied to the catalyst 100.

In the case of gas-reforming treatment, the electric-field catalyst is heated to a reaction temperature of 200° C. to 400° C. (473 K to 673 K), and furthermore, an electric field is applied. The electric-field catalyst in such a state is brought into contact with a gas to be reformed (e.g., a hydrocarbon), and thereby the gas is caused to react (caused to be reformed).

### EXAMPLES

The essence of the present disclosure lies in that a more efficient catalyst can be provided even if the optimal conditions vary depending on the substrate and the catalyst material to be employed, without limitation to Examples described herein.

A commercially available cylindrical honeycomb substrate made of cordierite (φ30 mm×30 mmt, the number of cells: 750 cpsi) (manufactured by NGK Insulators, Ltd., HONEYCERAM, 3 mil/750 cpsi) was used as the honeycomb substrate 110.

In regard to the high-resistance layer 120, BaCO₃, ZrO₂, and Y₂O₃ were weighed so that each element had a ratio shown in Table 2, and subjected to wet blending together with round pebbles and water added thereto, thereby obtaining a mixture. Note that, since Sample No. 13 did not contain Ba, respective raw materials were weighed so that the elements other than Ba had the mole ratios shown in Table 2.

The resulting mixture was dried in an oven at 120° C., and then fired under conditions of 1100° C. in an air atmosphere for 1 hour, thereby obtaining an insulating material.

The resulting insulating material, water as a solvent, and a pore-forming agent were mixed and blended in a ball mill for 2 hours, thereby preparing slurry for coating. An agent made of an acrylic resin having an average particle diameter of 1.8 μm (MX-180TA manufactured by Soken Chemical & Engineering Co., Ltd.) was employed as the pore-forming agent and added in an amount shown in Table 2, where the amount of total solids in the slurry was taken as 100 mass %.

All the surfaces of the honeycomb substrate 110 were coated (wash-coated) with the slurry for the high-resistance layer 120 in an amount shown in Table 2, followed by drying, thereby forming the high-resistance layer 120 (containing the pore-forming agent).

In regard to the catalyst layer 130, BaCO₃, ZrO₂, Y₂O₃, and RuO₂ were weighed so that each element had a ratio shown in Table 1, and subjected to wet blending together with round pebbles and water added thereto, thereby obtaining a mixture.

The resulting mixture was dried in an oven at 120° C., and then fired under conditions of 1100° C. in an air atmosphere for 1 hour, thereby obtaining a catalyst material.

The resulting catalyst material, water as a solvent, and a pore-forming agent were mixed and blended in a ball mill for 2 hours, thereby preparing slurry for coating. An agent made of an acrylic resin having an average particle diameter of 0.8 μm (MX-80H3wT manufactured by Soken Chemical & Engineering Co., Ltd.) was employed as the pore-forming agent and added in an amount shown in Table 1, where the amount of total solids in the slurry was taken as 100 mass %.

All the surfaces of the honeycomb substrate 110 having the high-resistance layer 120 formed thereon were coated (wash-coated) with the slurry for the catalyst layer 130 in an amount shown in Table 1, followed by drying, thereby forming the catalyst layer 130 (containing the pore-forming agent). The resulting object was subsequently fired at 800° C. for 3 hours. The pore-forming agent was eliminated during the firing due to combustion, thermal decomposition, or the like.

In this manner, catalyst samples for measurement were prepared.

In Sample 14 for comparison, the application of the slurry for the high-resistance layer 120 was omitted and therefore the catalyst layer 130 was directly formed on the surfaces of the honeycomb substrate 110.

The thickness 130t of the catalyst layer 130 and the thickness 120t of the high-resistance layer 120 were measured by observing cross-sectional surfaces of the sample by SEM (at a magnification of 1000 or 2000).

The honeycomb substrate 110 was cut to obtain a cross section (the cross section illustrated in FIGS. 1 and 2) orthogonal to the direction in which the cells 150 extend (the direction of the flow passage for the gas being treated). On the cross section, the thickness 130t of the catalyst layer 130 and the thickness 120t of the high-resistance layer 120 in the direction orthogonal to the one side 150L of the cell 150 (the direction along line X-X in FIG. 2) were measured almost at the center position of the one side of the cell 150. The thicknesses were automatically measured by image processing software.

Three cross sections were prepared, and in each of the sections, the thickness 130t of the catalyst layer 130 and the thickness 120t of the high-resistance layer 120 were measured in randomly extracted three sides. Arithmetic mean values of the results of measurement at the total 9 points were calculated for each sample, and taken as the thickness 130t of the catalyst layer 130 and the thickness 120t of the high-resistance layer 120 of the sample.

### <Evaluation of Activity>

An electric-field activity of the resulting sample was evaluated.

In the evaluation of activity, an activity in a steam reforming reaction was evaluated.

The honeycomb catalyst was set in a quartz reaction tube of a fixed-bed catalytic reaction apparatus, and electrodes made of SUS (positive electrode and negative electrode) were brought into contact with the upper and lower ends of the honeycomb. A reaction gas was introduced thereto with an electric furnace temperature set to 300° C., and an electric field was applied with a direct-current power source, thereby evaluating the electric field steam reforming reaction. The details of the reaction conditions were as follows.
Reaction gas: CH₄: 1200 cc/min, N₂: 240 cc/min
Steam: 2400 cc/min
Space velocity (SV): about 10000/h
S/C (steam/carbon ratio): 2.0
Electric furnace temperature: 300° C.

Note that the methane conversion rate without application of the electric field was 0%.

### <Evaluation of Resistivity>

In the present disclosure, resistance values of the respective layers are important design values. The resistivity (φ was evaluated by the following method, and the relationship with the catalytic activity was organized.

The ceramics and the pore-forming agents used for the catalyst layer 130 and the high-resistance layer 120 were prepared according to the mixing ratios shown in Tables 1 and 2. After adding a solvent and a binder, the mixture was blended and subjected to press molding. The molded article was fired at the same temperature as that for firing of the honeycomb, thereby obtaining a sample for the measurement of resistance.

The sample had a size of 4 mm×3 mm×30 mm, and was measured by the four-terminal method. The resistivity is expressed by the following formula, the value of which is normalized based on the thickness, width, and length, in which influences of the materials and pores, and the state of contact between the materials are taken into consideration.

$$ρ = R \times A / T ,$$

where
ρ: Resistivity (Ω·cm),
R: Resistance (Ω),
A: Cross-sectional area of the sample (cm²), and
T: Length of the sample (cm).

Table 3 shows measurement results obtained when an electric field was applied such that the input electric power was equal to 100 W.

Samples 1 to 13 correspond to Examples, in which the high-resistance layer 120 was provided between the honeycomb substrate 110 and the catalyst layer 130. The high-resistance layer 120 contributed to focusing the electric current on the catalyst layer 130, and thereby the methane conversion rate was improved (the methane conversion rate was higher than or equal to twice the methane conversion rate of Comparative Example described later).

Note that the high-resistance layer 120 was in any of the states illustrated in FIGS. 3 to 5, depending on the amount of material applied for formation of the high-resistance layer 120.

On the other hand, Sample 14 (Comparative Example) was not provided with the high-resistance layer 120. Accordingly, in Sample 14, the holes 110a being open on the surface 110s of the honeycomb substrate 110 were filled with part of the catalyst layer 130. The part 130a of the catalyst layer 130 inside the holes 110a did not come into contact with the gas being treated which passes through the cells 150 and thus scarcely contributed to the catalytic reaction; however, the electric current was allowed to pass through the part 130a. This is considered to have reduced the amount of electric current that flowed through certain portions of the catalyst layer 130 which contributed to the catalytic reaction (mainly the upper portions of the catalyst layer 130 neighboring the cells 150), resulting in a reduction in the methane conversion rate.

Samples 1 to 13 corresponding to Examples will be considered further in detail.

Sample 1 was provided with the catalyst layer 130 the thickness 130t of which was 10 μm, which was formed from a catalyst material having a Ru content (mole ratio) of 0.04. The thickness 120t of the high-resistance layer 120 was 10 μm. Since the amount of Ru in the catalyst layer was relatively small and the catalyst layer was relatively thin, the electrical resistance of the entire catalyst was relatively high; therefore, the methane conversion rate was low among the Examples.

Sample 2 was similar to Sample 1 except that the thickness 130t of the catalyst layer 130 was 20 μm. Since the catalyst layer was thicker than that of Sample 1, the electrical resistance of the entire catalyst was low and a large amount of electric current was allowed to flow, resulting in an improvement in the methane conversion rate.

Samples 3 to 5 were provided with the catalyst layer 130 the thickness 130t of which was 10 μm, in which their catalyst materials had different Ru contents (mole ratios), i.e., 0.08, 0.10, and 0.12. The thickness 120t of the high-resistance layer 120 was 10 μm. As the Ru content increased, the resistivity of the catalyst layer decreased, and the electrical resistance of the entire catalyst also decreased. However, the methane conversion rates of Samples 3 and 4, the Ru contents of which were relatively small, were higher than the methane conversion rate of Sample 5, the Ru content of which was relatively large. The reason for the above is considered as follows. That is, since the Ru content was large and thus the dispersibility of Ru was low, interfaces between Ru and Ba(Zr,Y)O₃, which are considered to be reaction fields for the electric-field catalytic reaction, were reduced.

Samples 6 to 9 were provided with the catalyst layer 130 formed from a catalyst material having a Ru content (mole ratio) of 0.08, in which the thickness 130t was varied in a range of 5 μm to 30 μm. The thickness 120t of the high-resistance layer 120 was 10 μm.

In Sample 6, in which the thickness 130t of the catalyst layer 130 was 5 μm, the electrical resistance of the entire catalyst was slightly high, and thus the methane conversion rate was slightly low.

In Sample 8, in which the thickness 130t of the catalyst layer 130 was 20 μm, and Sample 9, in which the thickness 130t was 30 μm, the methane conversion rate was lower than that of Sample 6, although the electrical resistance of the entire catalyst was low. The reason for the above is considered as follows. That is, since the catalyst layer 130 was thick, the lower portions of the catalyst layer (the portions near the honeycomb substrate 110 with respect to the thickness 130t of the catalyst layer 130) were not able to sufficiently contribute to the catalytic reaction.

In Sample 7, in which the thickness 130t of the catalyst layer 130 was 15 μm, the methane conversion rate was improved although the electrical resistance of the entire catalyst was high as compared to Samples 8 and 9.

Also in Sample 3, in which the Ru content (mole ratio) was 0.08 (the thickness 130t of the catalyst layer 130 was 10 μm), the methane conversion rate was improved as compared to Samples 8 and 9.

It was found from the above results that methane can be most efficiently converted when the thickness 130t of the catalyst layer 130 is 10 μm to 15 μm, provided that the Ru content (mole ratio) is 0.08.

In Samples 10 to 12, a Ru content (mole ratio) in the catalyst layer was fixed to 0.08 and the thickness 130t of the catalyst layer 130 was fixed to 10 μm, and the thickness 120t of the high-resistance layer 120 was varied in a range of 0 μm to 40 μm. In Sample 10, although the high-resistance layer 120 was formed by application in an amount of 40 g/L, only part of holes being open on the surface of the honeycomb substrate 110 (more accurately, only part of the space inside the holes) were filled therewith (FIG. 5). Therefore, “the thickness 120t of the high-resistance layer 120” measured from the surface 110s of the honeycomb substrate 110 was regarded as 0 μm.

In Sample 10, part of the holes 110a being open on the surface 110s of the honeycomb substrate 110 were not filled with the high-resistance material, and thus recessed portions were left on the surface 110s of the honeycomb substrate 110 (FIG. 5). Therefore, the part 130a of the catalyst layer 130 entered the recessed portions. It is considered that, since electric current flowing through the part 130a of the catalyst layer 130 did not contribute to the catalytic reaction, the methane conversion rate slightly decreased. In addition, since most of the surface 110s of the honeycomb substrate 110 was not coated with the high-resistance layer, the surface 110s of the honeycomb substrate 110 was in contact with the catalyst layer 130. Slight interdiffusion of elements in their contact surfaces was confirmed, which is estimated to be caused by a chemical reaction between the material constituting the honeycomb substrate 110 and the catalyst material constituting the catalyst layer 130, and such a chemical reaction is also considered to be one reason for the decrease in the methane conversion rate.

In Samples 11 and 12, the holes 110a being open on the surface 110s of the honeycomb substrate 110 and open to the catalyst layer 130 were completely filled with the high-resistance layer, and furthermore, all the surfaces of the honeycomb substrate were coated with the high-resistance layer. As a result, the methane conversion rate was remarkably improved.

Sample 13 was similar to Sample 3 except that the composition of the high-resistance layer 120 was changed so as not to contain Ba. The same degree of methane conversion rate as that in Sample 3 was achieved.

When the electrical resistivity of the high-resistance layer 120 was higher than or equal to twice the electrical resistivity of the catalyst layer 130, the electric-field catalytic reaction was efficiently induced (Samples 1 and 2). It is more preferable that the electrical resistivity of the high-resistance layer 120 be one or more orders of magnitude higher than the electrical resistivity of the catalyst layer 130 (Samples 3 to 13).

TABLE 1

| | Catalyst layer 130 | | | | | | | |
|---|---|---|---|---|---|---|---|---|
| | Content | | | | Pore-forming agent | | | |
| | (mole ratio, where the amount | | | | (mass %, where the | Thickness | Amount | Electrical |
| | of Ba is taken as 1.00) | | | | amount of solids is | 130t | applied | resistivity |
| Sample No. | Ba | Zr | Y | Ru | taken as 100 mass %) | (μm) | (g/L) | (Ω · cm) |
| 1 | 1.00 | 0.90 | 0.10 | 0.04 | 10 | 10 | 50 | 5012 |
| 2 | 1.00 | 0.90 | 0.10 | 0.04 | 10 | 20 | 100 | 5012 |
| 3 | 1.00 | 0.90 | 0.10 | 0.08 | 10 | 10 | 50 | 158 |
| 4 | 1.00 | 0.90 | 0.10 | 0.10 | 10 | 10 | 50 | 126 |
| 5 | 1.00 | 0.90 | 0.10 | 0.12 | 10 | 10 | 50 | 63 |
| 6 | 1.00 | 0.90 | 0.10 | 0.08 | 10 | 5 | 30 | 158 |
| 7 | 1.00 | 0.90 | 0.10 | 0.08 | 10 | 15 | 80 | 158 |
| 8 | 1.00 | 0.90 | 0.10 | 0.08 | 10 | 20 | 100 | 158 |
| 9 | 1.00 | 0.90 | 0.10 | 0.08 | 10 | 30 | 150 | 158 |
| 10 | 1.00 | 0.90 | 0.10 | 0.08 | 10 | 10 | 50 | 158 |
| 11 | 1.00 | 0.90 | 0.10 | 0.08 | 10 | 10 | 50 | 158 |
| 12 | 1.00 | 0.90 | 0.10 | 0.08 | 10 | 10 | 50 | 158 |
| 13 | 1.00 | 0.90 | 0.10 | 0.08 | 10 | 10 | 50 | 158 |
| 14 (Comparative | 1.00 | 0.90 | 0.10 | 0.08 | 10 | 20 | 175 | 158 |
| Example) | | | | | | | | |

TABLE 2

| | | | | | | | | | Ratio of electrical |
|---|---|---|---|---|---|---|---|---|---|
| | High-resistance layer 120 | | | | | | | | resistivity |
| | Content (mole ratio, where | | | | Pore-forming agent | | | | High-resistance |
| | the amount of Ba is taken | | | | (mass %, where the | Thickness | Amount | Electrical | layer |
| | as 1.00) | | | | amount of solids is | 120t | applied | resistivity | (Ω · cm)/Catalyst |
| Sample No. | Ba | Zr | Y | Ru | taken as 100 mass %) | (μm) | (g/L) | (Ω · cm) | layer (Ω · cm) |
| 1 | 1.00 | 0.90 | 0.10 | 0.00 | 20 | 10 | 75 | 12589 | 2.5 |
| 2 | 1.00 | 0.90 | 0.10 | 0.00 | 20 | 10 | 75 | 12589 | 2.5 |
| 3 | 1.00 | 0.90 | 0.10 | 0.00 | 20 | 10 | 75 | 12589 | 79.7 |
| 4 | 1.00 | 0.90 | 0.10 | 0.00 | 20 | 10 | 75 | 12589 | 99.9 |
| 5 | 1.00 | 0.90 | 0.10 | 0.00 | 20 | 10 | 75 | 12589 | 199.8 |
| 6 | 1.00 | 0.90 | 0.10 | 0.00 | 20 | 10 | 75 | 12589 | 79.7 |
| 7 | 1.00 | 0.90 | 0.10 | 0.00 | 20 | 10 | 75 | 12589 | 79.7 |
| 8 | 1.00 | 0.90 | 0.10 | 0.00 | 20 | 10 | 75 | 12589 | 79.7 |
| 9 | 1.00 | 0.90 | 0.10 | 0.00 | 20 | 10 | 75 | 12589 | 79.7 |
| 10 | 1.00 | 0.90 | 0.10 | 0.00 | 20 | 0 | 40 | 12589 | 79.7 |
| 11 | 1.00 | 0.90 | 0.10 | 0.00 | 20 | 20 | 100 | 12589 | 79.7 |
| 12 | 1.00 | 0.90 | 0.10 | 0.00 | 20 | 40 | 150 | 12589 | 79.7 |
| 13 | 0.00 | 0.80 | 0.20 | 0.00 | 20 | 10 | 100 | 1002300 | 63243.7 |
| 14 (Comparative | — | — | — | — | | — | | | |
| Example) | | | | | | | | | |

TABLE 3

| | Electric | Electric | | CH₄ conversion |
|---|---|---|---|---|
| | power | current | Voltage | rate |
| Sample No. | (W) | (mA) | (V) | (%) |
| 1 | 100 | 25 | 4000 | 30 |
| 2 | 102 | 70 | 1450 | 38 |
| 3 | 100 | 80 | 1250 | 42 |
| 4 | 100 | 125 | 800 | 41 |
| 5 | 100 | 160 | 625 | 38 |
| 6 | 100 | 100 | 1000 | 40 |
| 7 | 100 | 120 | 835 | 43 |
| 8 | 100 | 200 | 500 | 35 |
| 9 | 98 | 280 | 350 | 30 |
| 10 | 96 | 80 | 1200 | 36 |
| 11 | 100 | 80 | 1250 | 50 |
| 12 | 98 | 80 | 1230 | 49 |
| 13 | 101 | 78 | 1300 | 40 |
| 14 (Comparative | 98 | 350 | 280 | 15 |
| Example) | | | | |

The catalyst according to the present disclosure is expected to achieve a catalytic reaction at low temperature, when applied to steam reforming, tri-reforming, dry reforming, a methanation treatment, a reverse water gas shift (RWGS) reaction, a reaction for oxidative coupling of methane (OCM), synthesis of ammonia, a dehydrogenation reaction of methylcyclohexane (MCH), exhaust methane treatment, a three-way catalytic reaction, or the like.

### REFERENCE SIGNS LIST

100, 101, 102 catalyst
110 honeycomb substrate
110a hole
110s surface of honeycomb substrate
120 high-resistance layer
130 catalyst layer
150 cell
160 partition wall

1. An electric field catalyst comprising:
a porous honeycomb substrate;
a catalyst layer covering a surface of the porous honeycomb substrate; and
a high-resistance layer that is higher in electrical resistivity than the catalyst layer between the porous honeycomb substrate and the catalyst layer.

2. The electric field catalyst according to claim 1, wherein an electrical resistivity of the high-resistance layer is higher than or equal to twice an electrical resistivity of the catalyst layer.

3. The electric field catalyst according to claim 1, wherein an electrical resistivity of the high-resistance layer is three times or more an electrical resistivity of the catalyst layer.

4. The electric field catalyst according to claim 1, wherein an electrical resistivity of the high-resistance layer is ten times or more an electrical resistivity of the catalyst layer.

5. The electric field catalyst according to claim 1, wherein an electrical resistivity of the high-resistance layer is fifty times or more an electrical resistivity of the catalyst layer.

6. The electric field catalyst according to claim 1, wherein
holes of the porous honeycomb substrate are open on the surface of the honeycomb substrate, and
at least part of the holes are filled with the high-resistance layer.

7. The electric field catalyst according to claim 6, wherein among the at least part of the holes, some of the holes are filled with the high-resistance layer and other holes are not filled with the high-resistance layer.

8. The electric field catalyst according to claim 6, wherein among the at least part of the holes, part of the pore volume of the holes are filled with the high-resistance layer.

9. The electric field catalyst according to claim 6, wherein the high-resistance layer fills all of the holes, and entirely coats the surface of the porous honeycomb substrate.

10. The electric field catalyst according to claim 6, wherein the high-resistance layer fills all of the holes, and a surface of the high-resistance layer and the surface of the porous honeycomb substrate are on a same plane.

11. The electric field catalyst according to claim 6, wherein the high-resistance layer fills part of an inner cavity of the holes such that a surface of the high-resistance layer does not reach the surface of the porous honeycomb substrate such that the surface of the porous honeycomb substrate has recessed portions.

12. The electric field catalyst according to claim 11, wherein the recessed portions are filled with a part of the catalyst layer.

13. The electric field catalyst according to claim 1, wherein
the catalyst layer comprises an electric-field catalyst material containing Ru, Ba, Zr, Y, and O, and
the high-resistance layer comprises an insulating material containing Ba, Zr, Y, and O.

14. The electric field catalyst according to claim 13, wherein the electric-field catalyst material contains an oxide of Ba, Zr, and Y as a principal component, and Ru as an active metal.

15. The electric field catalyst according to claim 14, wherein, when a content of Ba is taken as 1.0 mol, Y: 0 to 0.03 mol, and Ru: 0.04 to 0.20 mol.

16. The electric field catalyst according to claim 1, wherein the surface of the porous honeycomb substrate is completely coated with the high-resistance layer.
